(19) United States
(12) Patent Application Publication
(10) Pub. No.: US 2022/0225577 A1
(43) Pub. Date: Jul. 21, 2022

(54) PLANT GROWING VESSELS AND HOLDING TRAYS

(71) Applicant: Maui Greens, Inc., Kula, HI (US)

(72) Inventors: Kevin Robell, Kula, HI (US); Kyle Robell, Kula, HI (US); Mark Stumpo, Grand Haven, MI (US)

(73) Assignee: Maui Greens, Inc., Kula, HI (US)

(21) Appl. No.: 17/576,589

(22) Filed: Jan. 14, 2022

Related U.S. Application Data
(60) Provisional application No. 63/252,533, filed on Oct. 5, 2021.
(60) Provisional application No. 63/236,512, filed on Aug. 24, 2021.
(60) Provisional application No. 63/138,391, filed on Jan. 15, 2021.
(60) Provisional application No. 63/138,389, filed on Jan. 15, 2021.

(51) Int. Cl. A01G 9/029; A01C 23/04

(52) U.S. Cl. CPC A01G 9/0297; A01G 9/0299; A01C 23/042

(57) ABSTRACT

A plant growing tray system, and a method of using the same, the system comprising a growing tray including a plurality of tray insert openings configured to accept tray inserts, a pallet stop, and a transfer catch. The system further comprises a plurality of tray inserts comprising a plurality of tray locking points configured to secure each of the plurality of tray inserts within the plurality of tray insert openings, a vessel cavity to hold a plant vessel, a plurality of fertigation holes on the bottom of the vessel cavity configured to receive fertigation needles, and a plurality of plant vessel securement points configured to secure the plant vessel within the vessel cavity.

### CROSS-REFERENCE TO RELATED APPLICATIONS

This application claims the benefit of U.S. Provisional Patent Application No. 63/252,533, filed on Oct. 5, 2021, the benefit of U.S. Provisional Patent Application No. 63/236,512, filed on Aug. 24, 2021, the benefit of U.S. Provisional Patent Application No. 63/138,389, filed on Jan. 15, 2021, and the benefit of U.S. Provisional Patent Application No. 63/138,391, filed on Jan. 15, 2021, each of which is incorporated herein by reference in its entirety.

### BACKGROUND

The inherent difficulties of growing, maintaining, and shipping large individual quantities of edible plant matter are sufficiently extensive that the field doesn't have a particularly strong record of innovation. Mistakes at any point in the growing, maintaining, and/or shipping process(es) often instantly lead to unusable products, with no possibility of recovery or regeneration. In short, the methods and apparatus for growing, maintaining, and shipping large individual quantities of edible plant matter impose requirements of precision wholly unknown in most other industries. Each individual stage for the methods and apparatus imposes its own separate challenges.

Existing fertigation systems encounter several challenges when attempting to fertigate a large quantity of plants, each plant or group of plants at differing growth stages—from seeds or seedlings to shoots of plants to plants —and thereby requiring differing quantities of water, nutrients, air, and so on.

“Plant” in this disclosure refers to a living organism of the kind exemplified by trees, shrubs, herbs, grasses, ferns, and mosses, typically growing in a permanent site, absorbing water and inorganic substances through its roots, and synthesizing nutrients in its leaves by photosynthesis. “Seed” in this disclosure refers to a flowering plant's unit of reproduction, capable of developing into another such plant. “Seedling” in this disclosure refers to a young plant, especially one raised from seed and not from a cutting. “Shoots of plants” in this disclosure refers to new growth from seed germination that grows upward and where leaves will develop. Shoots may also refer to stems including their appendages, the leaves and lateral buds, flowering stems and flower buds.

Plants grow at differing rates and need a combination of customized liquid, solid and gaseous nutrients if they are to reach their full growth potential. Plants growing in large collections may need monitoring at all growth stages, not least to adjust their fertigation needs as they mature. Individual plants, regardless of the scale at which they are grown and maintained, also need more than soil, water, light, and nutrients, though all four are important. The locations of these components and the timing schedule at which they are delivered to a growing plant are additionally central for plant growth.

Existing vessels for growing individual plants in large quantities exhibit several obstacles to successfully delivering packaged edible products. These obstacles include effectively delivering water and nutrients to the plants and controlling the climate conditions around the plant given the potential interactions between the plant and the growing medium as well as the interaction of the growing medium with the surroundings within the microclimate. Additional obstacles include protection against harsh handling when the plants are distributed, evaporation, effective watering of the growing medium, etc.

A need therefore exists for a system for controlling, storing, feeding, efficiently growing, monitoring, and delivering individually secured and maintained edible plant products. For efficient transfer of growing plants within a fertigation system, there is further a need for a tray system capable of holding multiple plants both within a growing rack, during fertigation at a fertigation station, and in transit between these and other locations within a growing facility.

### BRIEF SUMMARY

In one aspect, a plant growing tray system, the system includes a growing tray including a plurality of tray insert openings configured to accept tray inserts, and a growing tray gripping area. The system also includes a plurality of tray inserts includes a plurality of tray locking points configured to secure each of the plurality of tray inserts within the plurality of tray insert openings, a vessel cavity configured to hold a plant vessel, and a plurality of fertigation holes on a bottom of the vessel cavity configured to receive fertigation needles.

In one aspect, a method, includes placing a plurality of tray inserts into tray insert openings of a growing tray of a plant growing tray system, where tray locking points secure each of the plurality of tray inserts within the plurality of tray insert openings, placing the plant growing tray system into a grow module, where the growing tray includes a pallet stop to secure the growing tray within the grow module, and removing the plant growing tray system from the grow module.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B illustrate a growing tray 100 in accordance with one embodiment.

FIG. 2A and FIG. 2B illustrate a growing tray 200 in accordance with one embodiment.

FIG. 3A-FIG. 3E illustrate a tray insert 300 in accordance with one embodiment.

FIG. 4A and FIG. 4B illustrate plant vessels 400 in accordance with one embodiment.

FIG. 5A and FIG. 5B illustrate rigid plant vessels 500 in accordance with one embodiment.

FIG. 6A-FIG. 6B illustrate a tray insert with plant vessel 600 in accordance with one embodiment.

FIG. 7A-FIG. 7E illustrate a plant growing tray system 700 in accordance with one embodiment.

FIG. 8 illustrates a growing tray with tray insert openings for pillow-shaped plant vessels 800 in accordance with one embodiment.

FIG. 9 illustrates a growing tray with pillow-shaped plant vessels 900 in accordance with one embodiment.

FIG. 10 illustrate growing trays with round tray insert openings 1000 in accordance with one embodiment.

FIG. 11 illustrates a growing tray with round plant vessels 1100 in accordance with one embodiment.

FIG. 12 illustrates a grow module with automated tray transferring device 1200 in accordance with one embodiment.

### DETAILED DESCRIPTION

The disclosed solution comprises a plant growing tray system capable of holding multiple growing plants securely as they are moved around a growing facility, to and from growing racks, fertigation stations, other locations in the facility, and potentially during shipment from the facility to retail locations. In this manner, live produce may be effectively and efficiently grown, shipped, sold, and consumed, retaining freshness and nutrition better than produce that is harvested before shipping.

The plant growing tray system may comprise a growing tray including a plurality of tray insert openings configured to accept tray inserts. A pallet stop and a transfer catch may be included to facilitate robotic transfer of the tray from growing rack pallets to fertigation stations. The transfer catch may allow a robotic gantry arm to latch onto the growing tray for transport. The pallet stop may allow the transfer system to recognize when the tray has been completely and securely replaced in a pallet.

The plant growing tray system may further comprise a plurality of tray inserts that may be placed within the tray insert openings of the growing tray. The tray inserts may include tray locking points that secure the tray insert within the tray insert opening of the growing tray. The tray inserts may also each have a vessel cavity that may hold a plant vessel containing growth medium and seeds or root mass as the plant grows within the plant growing tray system. The vessel cavity may be configured to contain a sausage-type plant vessel. The sausage-type plant vessel may comprise a pierceable, biodegradable membrane disposed around a mass of growth medium having a cylindrical shape and rounded ends. The ends may be closed off by pinching, clamping, twisting, tying, heat sealing, or otherwise securing the ends.

The vessel cavity may alternatively be configured to contain a pillow-type plant vessel, similar in construction to the sausage-type plant vessel, but of a flatter shape, either round, oblong, rectangular, or some other shape. The vessel cavity may also be configured to hold conventional round or square growing pots or other plant vessel types disposed to hold growing medium and growing plants, and to allow fertigation of these plants during growth.

The tray insert may further include a plurality of fertigation holes on the bottom of the vessel cavity configured to receive fertigation needles. These allow the fertigation needles at a fertigation station to penetrate the vessel cavity and plant vessel and deliver water, gases, and nutrients into the plant vessel while it remains in the tray insert.

The fertigation needles may exert enough pressure at early stages of growth, before established needle channels have been created by repeated fertigation, to dislodge the plant vessel from the tray insert vessel cavity. For this reason, the tray insert may further comprise a plurality of plant vessel securement points configured to secure the plant vessel within the vessel cavity. The plant vessel securement points in one embodiment may be a series of pressure ridges configured to extend into the vessel cavity and apply pressure and friction to an inserted plant vessel. In another embodiment, plant vessel securement points may be gripper hold-down slots at the edges of the vessel cavity. The gripper hold-down slots may allow a gripper to be attached across the top of the vessel cavity to hold the plant vessel secure within the vessel cavity.

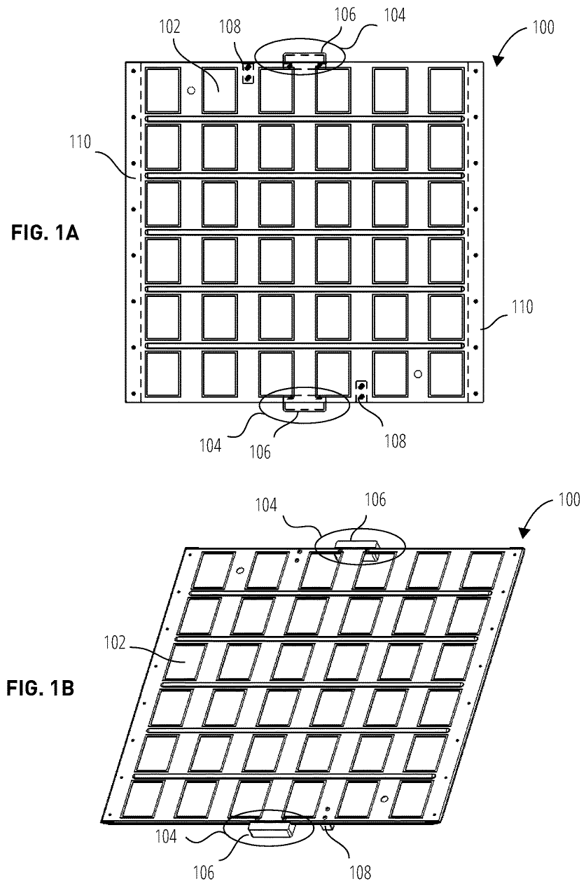

FIG. 1A and FIG. 1B illustrate a growing tray 100 in accordance with one embodiment. FIG. 1A shows a top view of a growing tray 100 embodiment manufactured from aluminum. FIG. 1B illustrates an isometric top view of the aluminum growing tray 100. The growing tray 100 comprises a plurality of tray insert openings 102, a growing tray gripping area 104 that may comprise transfer catches 106, a pallet stop 108, and thickness strips 110.

In one embodiment, as illustrated in FIG. 1A, the growing tray 100 may comprise thirty-six tray insert openings 102, as shown, in order to transfer thirty-six separate plants or groups of plants around a growing facility. This number may be adjusted to allow more smaller plants or fewer larger plants within a footprint compatible with growing racks, which may be standardized throughout a growing facility. The transfer catches 106 may allow a robotic gantry arm to latch onto the growing tray 100 for transport. A transfer catch 106 may be provided on two sides of a growing tray 100 such that either end of the growing tray 100 may be grabbed for transport.

In one embodiment, as shown in FIG. 1B, in addition to the tray insert openings 102 and growing tray gripping areas 104 such as transfer catches 106, the growing tray 100 may comprise two pallet stops 108, one on each end also having the transfer catches 106. These pallet stops 108 may allow a robotic transport system to recognize when the growing tray 100 is securely and completely seated in a pallet.

Aluminum sheeting may be selected to construct a growing tray that has a thickness adequate to support the weight of fully loaded tray inserts. This thickness may be no more than is adequate for this weight to conserve material and reduce cost. As such, this thickness of aluminum may not be compatible with holding pallet configurations. Thickness strips 110 may be configured on the two edges of the growing tray 100 that slide along pallet or rack rails in order to make the growing tray 100 compatible with these rails. The thickness strip 110 may be made of materials such as High Density Polyethylene (HDPE). This material may reduce friction against rails as well as bring the aluminum edges of the growing tray 100 up to thickness dimensions compatible with the railed systems.

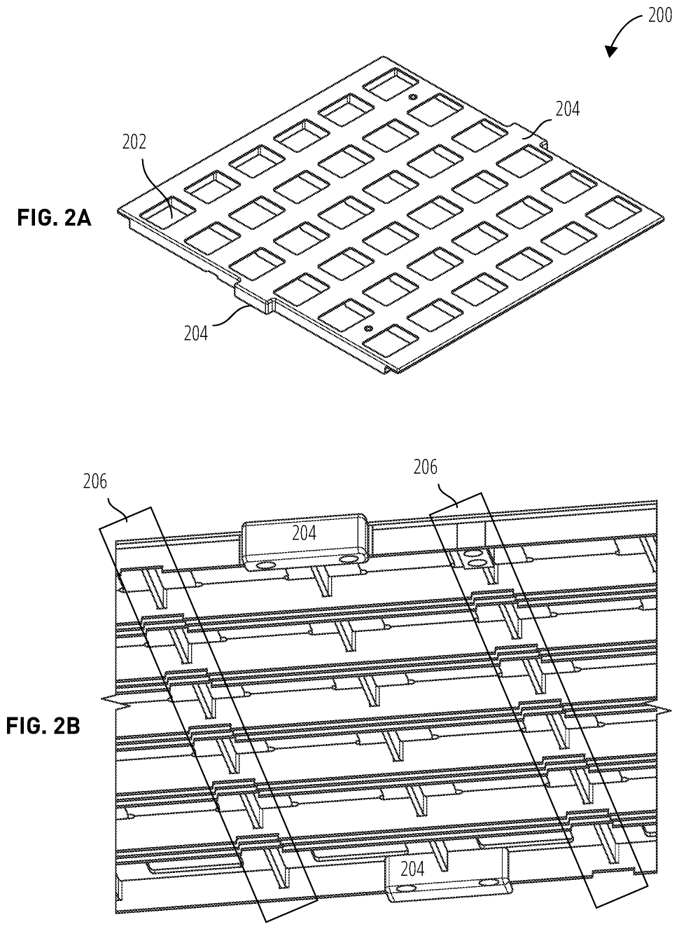

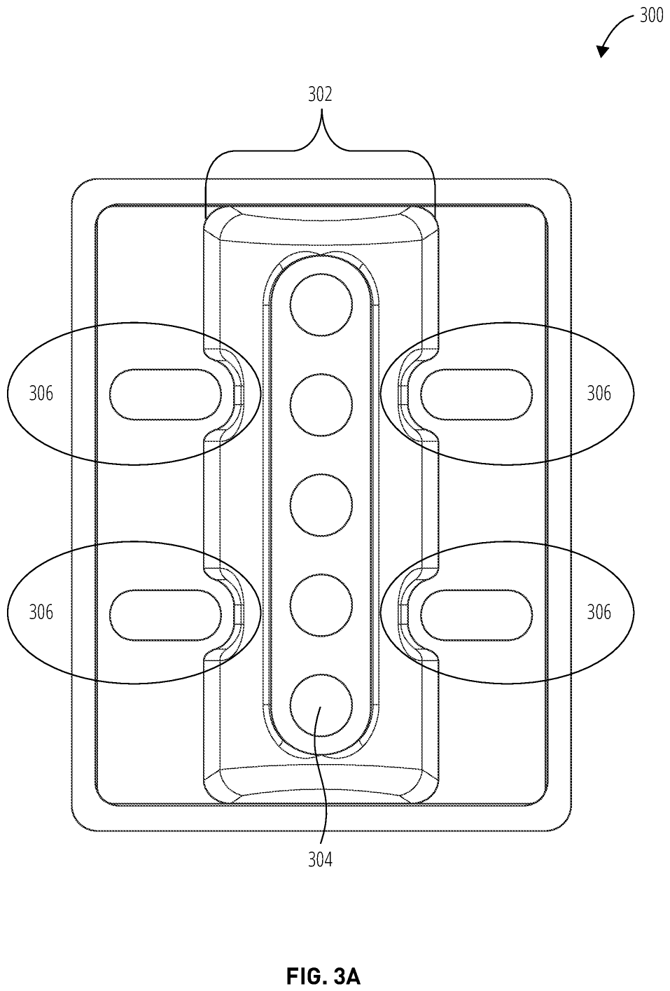

FIG. 2A and FIG. 2B illustrate a growing tray 200 in accordance with one embodiment. FIG. 2A illustrates a top isometric view of a growing tray 200 embodiment manufactured from molded plastic. FIG. 2B illustrates an isometric underside view of the molded plastic growing tray 200. The molded plastic growing tray 200 comprises a plurality of tray insert openings 202, transfer catches 204, and pallet stops 206.

Rather than the separate and attached components used to form the transfer catches 106 of FIG. 1A and FIG. 1B, the transfer catches 204 in this embodiment may be integrated into the molded plastic of the growing tray 200. The pallet stop 206 may in some embodiments comprise a feature running along the bottom of the growing tray across its entire width, such that a pallet stop may contact a leading edge of a pallet and, on release, pop up under the tray without hitting it. An example of this slot feature is shown in FIG. 2B.

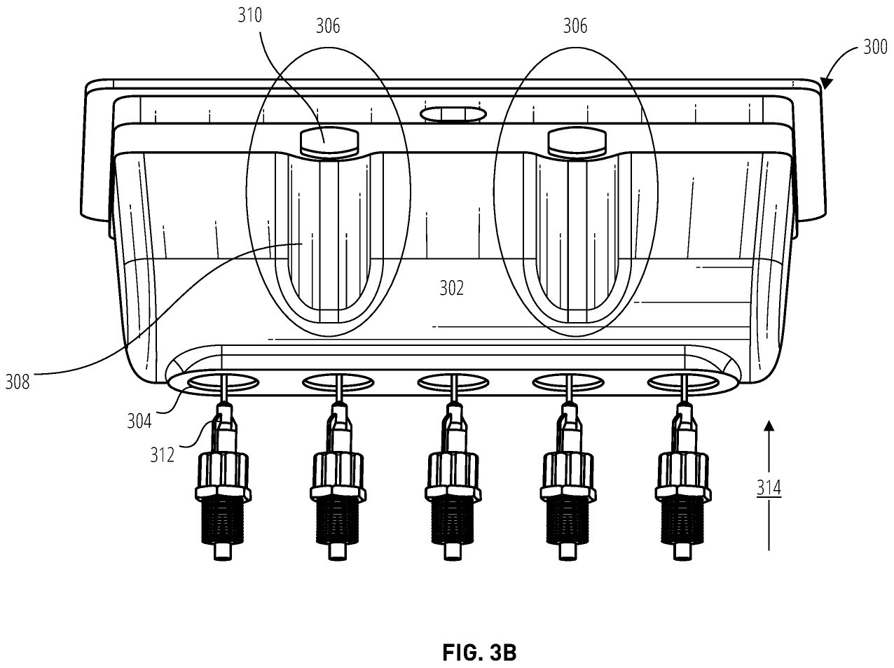

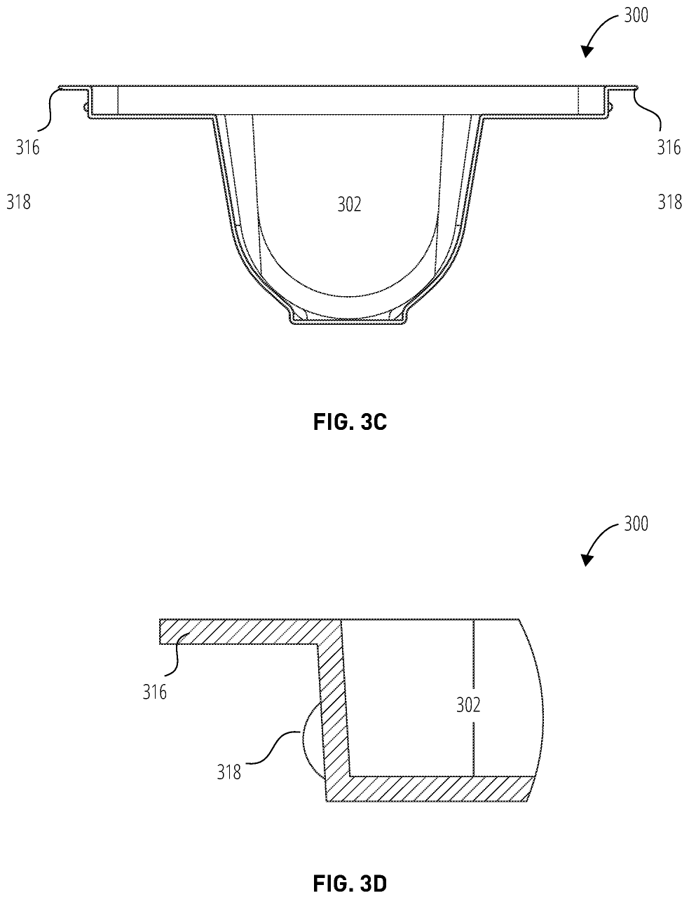

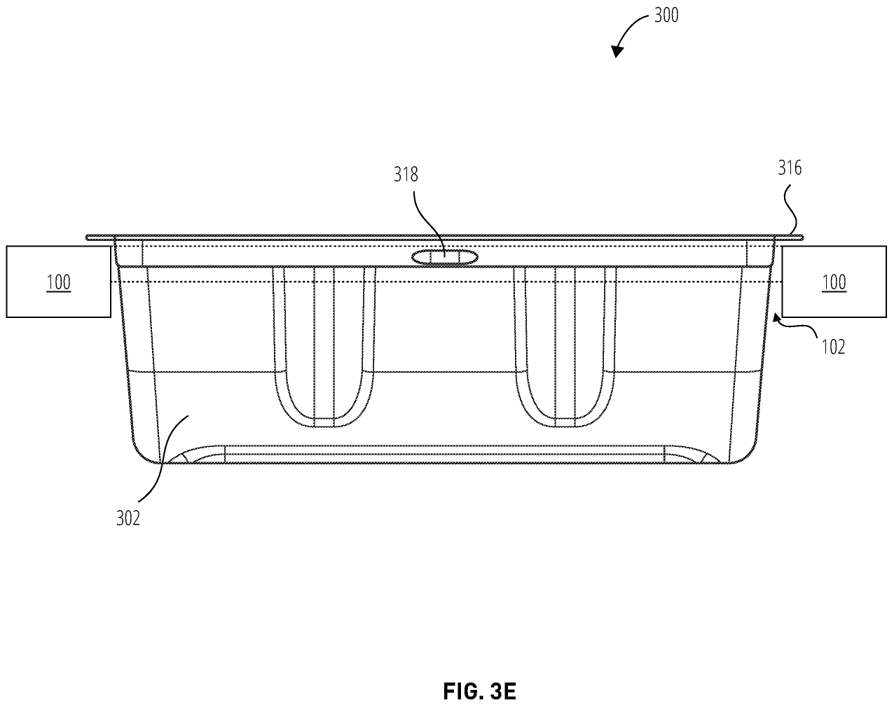

FIG. 3A-FIG. 3E illustrate a tray insert 300 in accordance with one embodiment. The tray insert 300 comprises a vessel cavity 302, a fertigation hole 304, a pressure ridge 308, an edge lip 316, a tray locking point 318, and a gripper hold-down slot 310.

FIG. 3A illustrates a top view of the tray insert 300. The vessel cavity 302 may be configured as shown to contain an elongated plant vessel such as a sausage-type plant vessel. The bottom of the vessel cavity 302 may comprise a plurality of fertigation holes 304 configured to allow the fertigation needles of a fertigation station to access the plant vessel. Plant vessel securement points 306 may be provided at the edges of the vessel cavity 302 to secure a plant vessel within the vessel cavity 302.

FIG. 3B shows an isometric bottom view of the tray insert 300. The plant vessel securement points 306 may be seen in greater detail as comprising both pressure ridges 308 and gripper hold-down slots 310. The side not visible in this view may be symmetrically configured, as indicated in the top view shown in FIG. 3A.

During fertigation, fertigation needles 312 may be pressed into the fertigation holes 304 in order to penetrate the plant vessel and deliver water, nutrients, and gasses into the growing medium within the plant vessel. The insertion of these fertigation needles 312 may exert a pressure 314 into the vessel cavity 302 which may be strong enough to dislodge the plant vessel within the vessel cavity 302. The pressure ridges 308 may extend into the vessel cavity 302 in order to exert pressure and friction upon an inserted plant vessel. This pressure and friction may act to hold the plant vessel in place within the vessel cavity 302 in spite of the pressure 314 exerted during fertigation. The gripper hold-down slots 310 may be configured to interface with a gripper at the edges of the vessel cavity 302 to allow the gripper to attach across the top of the plant vessel in order to hold it into place in spite of this pressure 314.

FIG. 3C and FIG. 3D illustrate a side view of the tray insert 300 and a side view detail of the tray insert 300, respectively. An edge lip 316 and a tray locking point 318 are shown illustrating how this embodiment may interface with the growing tray. When placed into a tray insert opening of a growing tray, the edge lip 316 may rest along the edges of the tray insert opening, preventing the tray insert 300 from falling through the tray insert opening. The tray locking point 318 may provide friction or pressure against the edge of the tray insert opening to hold the tray insert securely within the tray insert opening in spite of movement or pressure during fertigation. In one embodiment, the edges of the tray insert opening may comprise additional features interfacing with the tray locking points 318 to provide additional support or securement beyond pressure and friction.

FIG. 3E shows a side view of a tray insert 300 and illustrates how the vessel cavity 302 may be seated within the tray insert opening 102 while the edge lip 316 rests against the top of the growing tray 100 and the tray locking point 318 may contact the edge of the tray insert opening 102 to provide securement through friction and outward pressure against the growing tray 100.

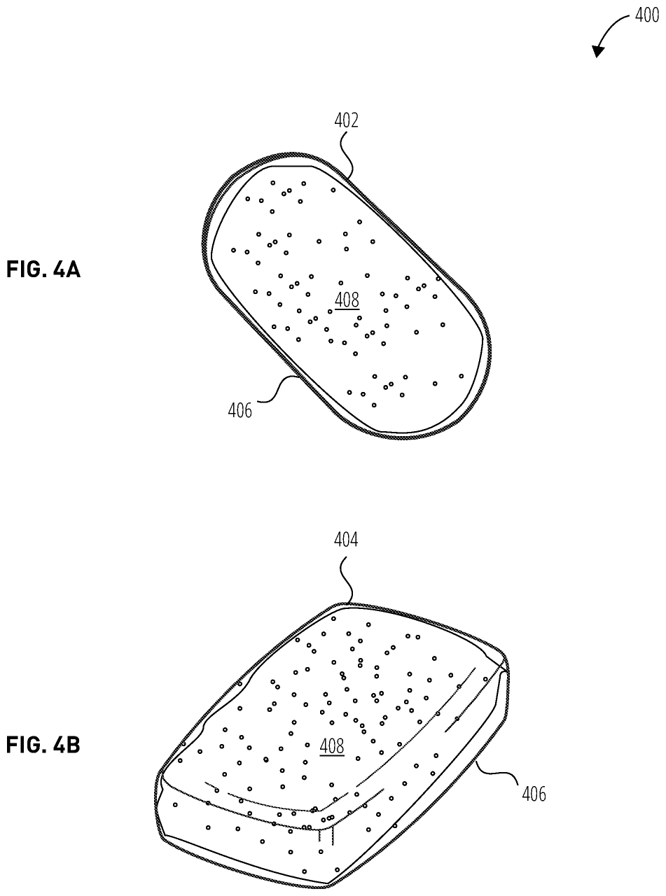

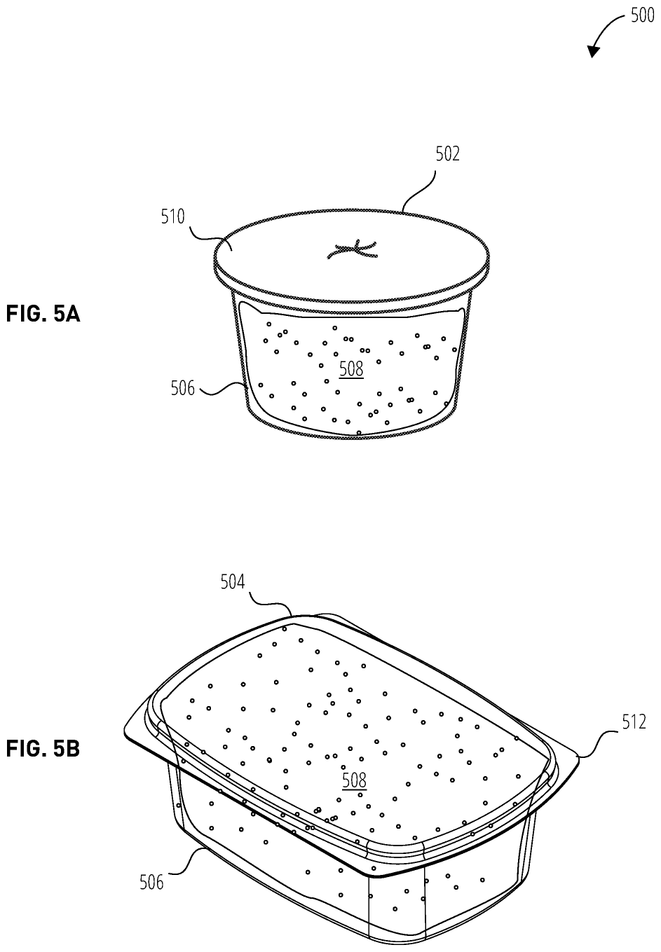

FIG. 4A and FIG. 4B illustrate plant vessels 400 in accordance with one embodiment. “Plant vessel” in this disclosure refers to container designed to facilitate individual plant growth. The plant vessel may include an outer membrane, an impervious outer vessel, a cover, a substrate, a nutrient chamber a pervious membrane, an outer membrane, and a root zone. “Substrate” in this disclosure refers to a biologically and chemically unreactive material that a plant may grow in or on.

The plant vessels 400 illustrated comprise the sausage-type plant vessel 402 of FIG. 4A having an outer membrane 406 and a substrate 408, as well as the pillow-shaped plant vessel 404 of FIG. 4B having an outer membrane 406 and a substrate 408. The outer membrane may be a flexible permeable or impermeable material intended to hold the substrate and root zone of a growing plant in place within the plant growing tray system, as well as to conserve moisture injected at fertigation from evaporation and protect the substrate inside from dispersal, fungus, or other damage.

FIG. 5A and FIG. 5B illustrate rigid plant vessels 500 in accordance with one embodiment. The tray insert openings may, in one embodiment, be configured to accommodate rigid plant vessels rather than or in addition to tray inserts. The rigid plant vessels 500 illustrated comprise the round plant vessel 502 of FIG. 5A and the rectangular plant vessel 504 of FIG. 5B. Both the round plant vessel 502 and the rectangular plant vessel 504 may comprise an outer membrane 506 containing a substrate 508. The round plant vessel 502 may be protected above by a round cover 510, maintaining the integrity of the substrate 508, the roots of a growing plant, and water and nutrients injected at fertigation. The rectangular plant vessel 504 may be protected by a rectangular cover 512 performing the same functions.

While the outer membranes 406 and 506 are illustrated as transparent, allowing visibility of the substrates, in one embodiment a vessel outer membrane may be opaque and/or have other insulating qualities. Managing root zone temperature to a constant target is important for healthy plant growth. With the changing ambient temperatures and nearby heat sources of equipment and lighting, the vessel outer membranes may be configured with insulating qualities such as material composition, color, opacity, and double wall construction. These qualities may assist in optimally achieving a desired root zone temperature, as well as maintaining complete darkness in the root zone, even while bright light is concentrated on the plant tissue. This may prevent the growth of algae or other pathogens in the root zone.

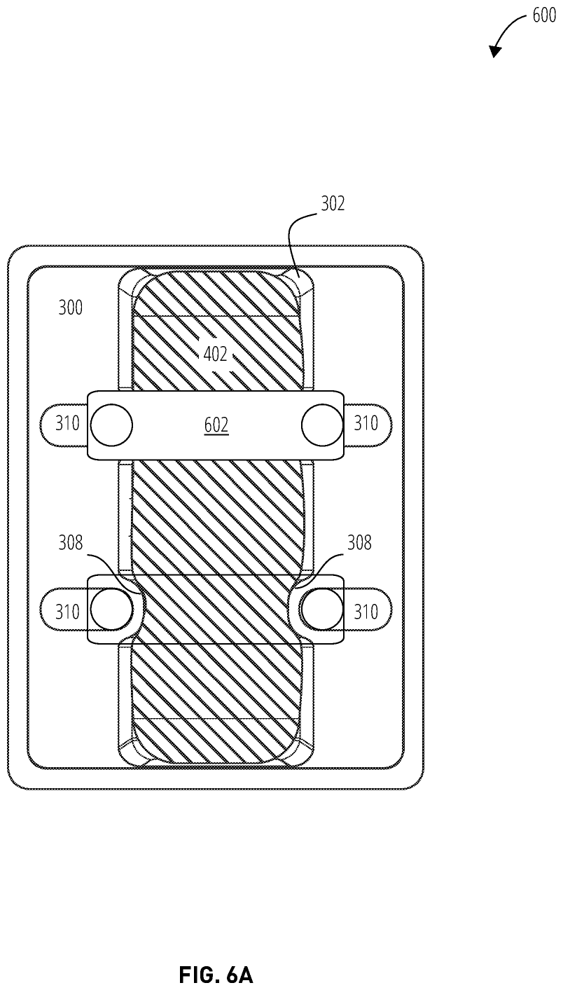

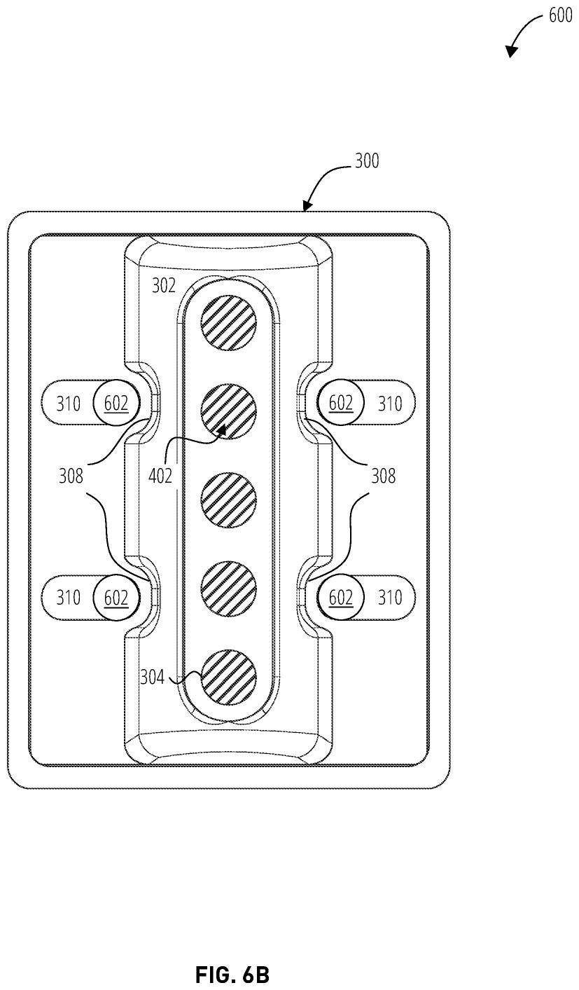

FIG. 6A-FIG. 6B illustrate a tray insert with plant vessel 600 in accordance with one embodiment. The tray insert with plant vessel 600 comprises a tray insert 300 with a plant vessel in place. The sausage-type plant vessel 402 may be a sausage-type plant vessel as shown and may rest within the vessel cavity 302 of the tray insert 300 as shown.

The pressure ridges 308 introduced with respect to FIG. 3B may be seen here exerting an inward pressure on the sausage-type plant vessel 402 such that the sausage-type plant vessel 402 may deform around the pressure ridges 308, increasing the surface area of the sausage-type plant vessel 402 in contact with the pressure ridges 308 and thus increasing the friction forces exerted to hold the sausage-type plant vessel 402 secure within the vessel cavity 302. Gripper hold-down slots 310 are also shown which would allow a gripper 602 to hold the sausage-type plant vessel 402 in place, as indicated. The gripper 602 may include portions that span the top of the sausage-type plant vessel 402 across the vessel cavity 302 as shown or may include fingers that extend from the bottom of the tray insert 300 up through the gripper hold-down slot 310 and over the vessel cavity 302 in another embodiment, or may be otherwise configured such that the gripper 602 may exert a downward counterpressure against the pressure from the fertigation needles to keep the plant vessel seated in the tray insert during fertigation.

FIG. 6B illustrates a bottom view of the tray insert with plant vessel 600. The sausage-type plant vessel 402 may be seen through the fertigation holes 304 resting on the bottom of the vessel cavity 302. In this manner, fertigation needles inserted into the fertigation hole 304 as illustrated in FIG. 3B may contact, pierce, and penetrate the outer membrane of the sausage-type plant vessel 402, in order to inject water and nutrients (i.e., fertigate) the substrate within the outer membrane, along with the seed or plant contained therein.

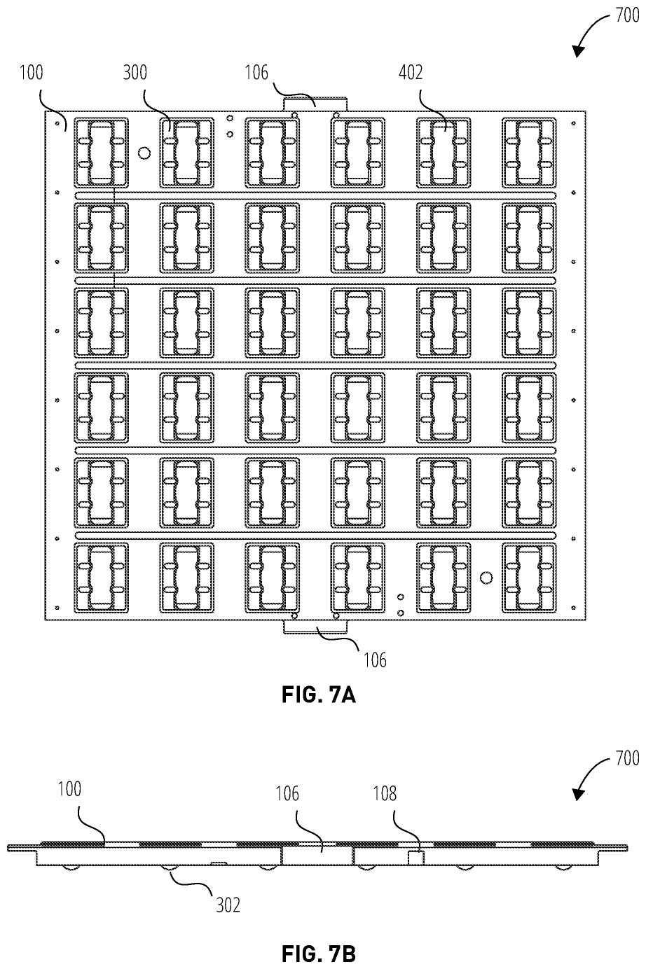

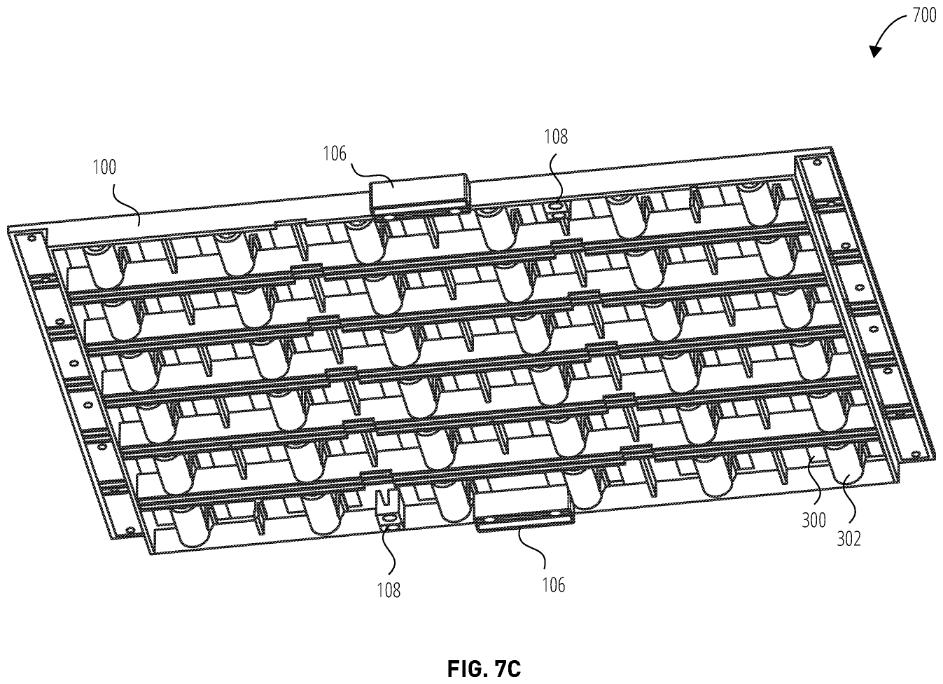

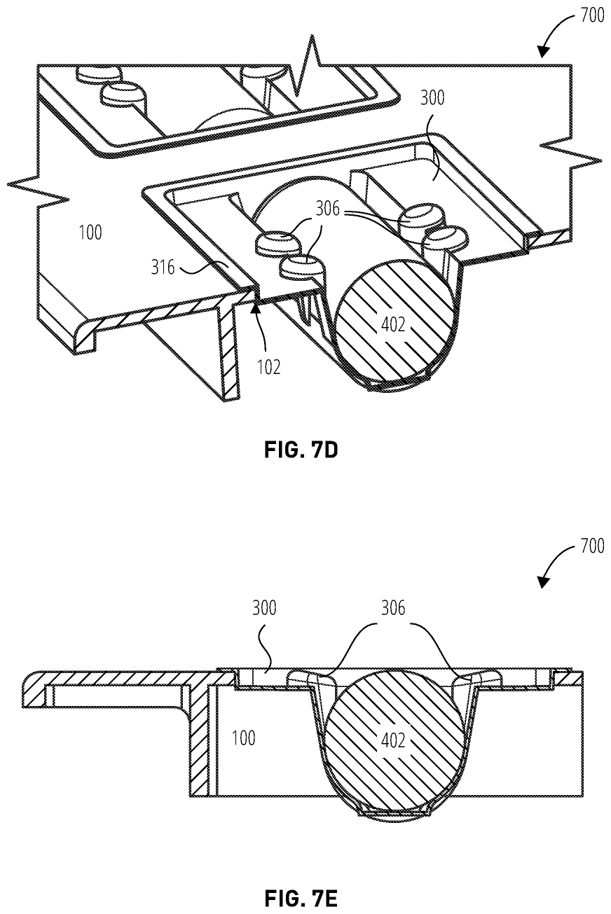

FIG. 7A-FIG. 7E illustrate a plant growing tray system 700 in accordance with one embodiment. FIG. 7A shows a top view of the plant growing tray system 700. The growing tray 100 may be seen, along with its transfer catch 106. The tray insert openings 102 are not visible in this view, as tray inserts 300 have been inserted into each one. sausage-type plant vessels 402 are seen within each tray insert 300. In this embodiment, the growing tray 100 is configured to hold thirty-six tray inserts 300. The tray inserts 300 shown are configured to hold sausage-type plant vessels.

FIG. 7B illustrates a side view of the plant growing tray system 700. The growing tray 100 with transfer catch 106 and pallet stop 108 are visible. The vessel cavities 302 of the tray inserts 300 may be seen extending down along the bottom of the growing tray 100.

FIG. 7C illustrates an isometric bottom view of the plant growing tray system 700. The growing tray 100 with transfer catch 106 and pallet stop 108 may be seen, along with the lower side of the tray inserts 300. The vessel cavities 302 are visible at the lower side of the growing tray 100.

FIG. 7D illustrates a detailed isometric top view of a portion of the plant growing tray system 700. The growing tray 100 may be seen with a tray insert 300 resting in a tray insert opening 102. The edge lip 316 prevents the tray insert 300 from slipping through the tray insert opening 102. The sausage-type plant vessel 402 is visible within the vessel cavity. The plant vessel securement points 306 are shown providing pressure and friction upon the sausage-type plant vessel 402 within the tray insert 300.

FIG. 7E illustrates a detailed side view of a portion of the plant growing tray system 700. The sausage-type plant vessel 402 may be seen held in the tray insert 300 with side pressure from the plant vessel securement points 306. The tray insert 300 rests in the growing tray 100.

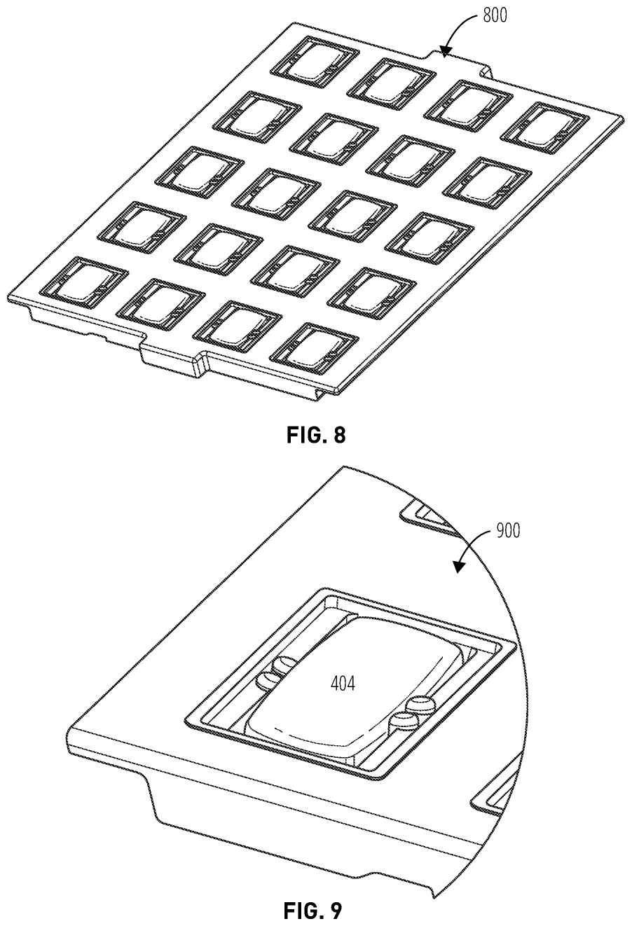

FIG. 8 illustrates a growing tray with tray insert openings for pillow-shaped plant vessels 800 in accordance with one embodiment.

FIG. 9 illustrates a growing tray with pillow-shaped plant vessels 900 in accordance with one embodiment.

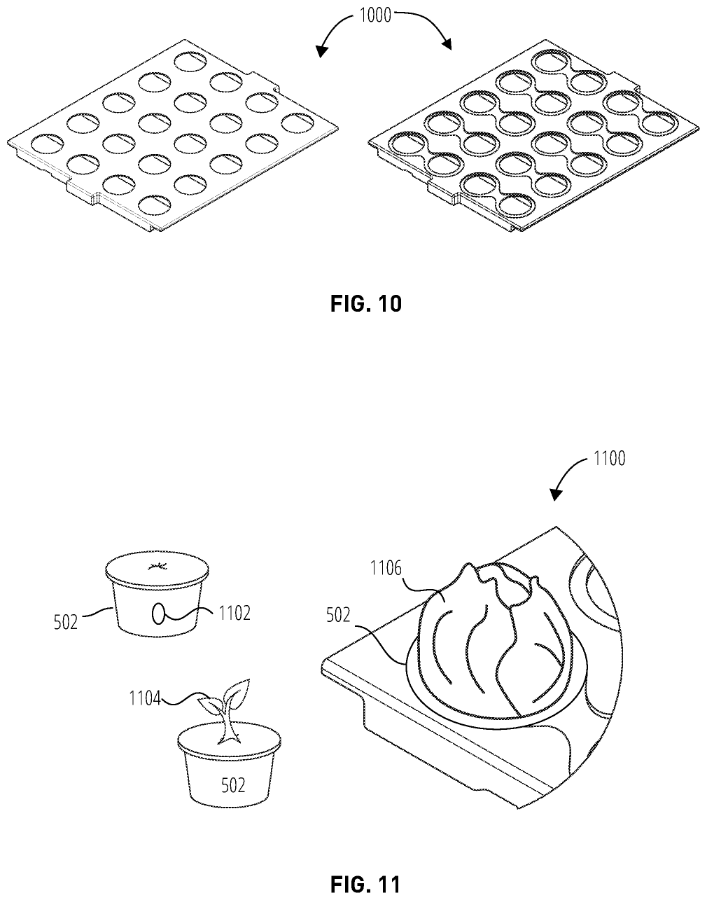

FIG. 10 illustrates growing trays with round tray insert openings 1000 in accordance with several embodiments.

FIG. 11 illustrates a growing tray with round plant vessels 1100 in one embodiment. A seed 1102 may be seen placed within the substrate of one of the round plant vessels 502. In another of the round plant vessels 502, a sprouting plant 1104 may be seen. Finally, in the round plant vessel 502 positioned within the growing tray with round plant vessels 1100, a grown plant 1106 may be seen growing up and out from its round plant vessel 502.

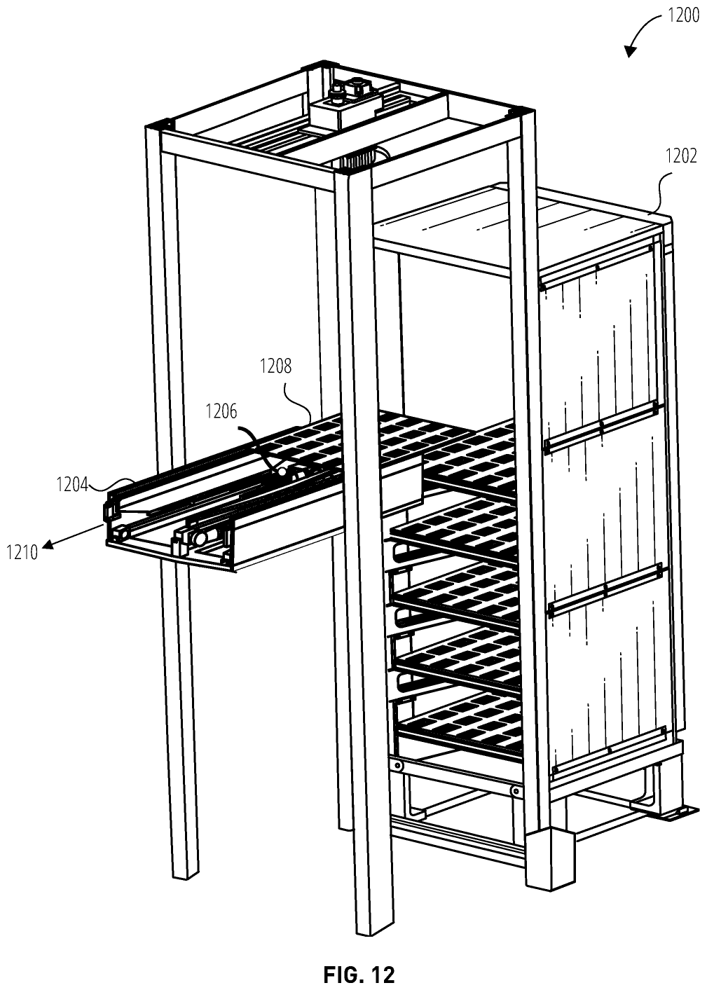

FIG. 12 illustrates a grow module with automated tray transferring device 1200 in accordance with one embodiment. “Grow module” in this disclosure refers to a storage medium for a plurality of growing trays to be extracted and inserted by the fertigation system. A grow module 1202 may be a rack or other system capable of holding a plurality of growing trays 1208. The growing trays 1208 may have transfer catches 106 as introduced in earlier sections. These transfer catches may be designed for compatibility with end of arm tooling 1206 installed at the end of an arm of the automated tray transferring device 1204. In this manner, the automated tray transferring device 1204 may attach to or otherwise grip a growing tray 1208, and exert a force to pull it out of the grow module 1202. Friction of the growing tray 1208 against rails or shelves within the grow module 1202 may be reduced through the action of the thickness strips 110 previously described. The thickness strips 110 may further act to maintain the gripping area of the growing tray 1208 at an appropriate height for engagement between the transfer catch and the end of arm tooling 1206.

The growing trays 1208 may be thus removed from the grow module 1202 for the purpose of transferring growing trays to a fertigation station 1210, where water and nutrients may be injected into a plant vessel contained in the growing tray 1208 as described with respect to FIG. 3A. The automated tray transferring device 1204 may further attach to or grip the growing trays 1208 for the purpose of returning fertigated growing trays 1208 to the grow module 1202. The growing tray 1208 may also be removed from the grow module 1202 for the purpose of populating a plant vessel within a growing tray and removing the plant growing tray system from the grow module at the end of a growth cycle for a grown plant residing in the plant vessel.

The methods, apparatuses, and systems in this disclosure are described in the preceding on the basis of several preferred embodiments. Different aspects of different variants are considered to be described in combination with each other such that all combinations that upon reading by a skilled person in the field on the basis of this document may be regarded as being read within the concept of the disclosure. The preferred embodiments do not limit the extent of protection of this document.

Having thus described embodiments of the present disclosure of the present application in detail and by reference to illustrative embodiments thereof, it will be apparent that modifications and variations are possible without departing from the scope of the present disclosure.

What is claimed is:

1. A plant growing tray system, the system comprising:
a growing tray including:
a plurality of tray insert openings configured to accept tray inserts; and
a growing tray gripping area;
a plurality of tray inserts comprising:
a plurality of tray locking points configured to secure each of the plurality of tray inserts within the plurality of tray insert openings;
a vessel cavity configured to hold a plant vessel; and
a plurality of fertigation holes on a bottom of the vessel cavity configured to receive fertigation needles.

2. The plant growing tray system of claim 1, the growing tray further including:
a pallet stop, wherein the pallet stop secures the growing tray within a grow module.

3. The plant growing tray system of claim 1, the growing tray gripping area comprising:
a transfer catch, wherein the transfer catch provides a point of attachment for an automated tray transferring device.

4. The plant growing tray system of claim 3, wherein the transfer catch is designed for compatibility with end of arm tooling implemented on the automated tray transferring device.

5. The plant growing tray system of claim 1, the plurality of tray inserts further comprising a plurality of plant vessel securement points configured to secure the plant vessel within the vessel cavity.

6. The plant growing tray system of claim 1, wherein the vessel cavity is configured to hold one of:
a sausage-type plant vessel; and
a pillow-shaped plant vessel.

7. The plant growing tray system of claim 1, wherein the plurality of tray insert openings are configured to accommodate at least one rigid plant vessel.

8. The plant growing tray system of claim 1, wherein the at least one rigid plant vessel is at least one of a round plant vessel and a rectangular plant vessel.

9. The plant growing tray system of claim 1, each of the plurality of plant vessel securement points comprising at least one of:
a pressure ridge, the pressure ridge extending into the vessel cavity to exert friction and pressure upon the plant vessel when inserted; and
a gripper hold-down slot, the gripper hold-down slot configured at an edge of the vessel cavity, the gripper hold-down slot configured to attach a gripper across a top of the vessel cavity to hold the plant vessel secure within the vessel cavity.

10. The plant growing tray system of claim 1, further including at least one plant vessel, the at least one plant vessel comprising:
an outer membrane; and
a substrate contained within the outer membrane.

11. The plant growing tray system of claim 10, wherein the at least one plant vessel is one of:
a sausage-type plant vessel;
a pillow-shaped plant vessel;
a round plant vessel, further comprising a round cover; and
a rectangular plant vessel, further comprising a rectangular cover.

12. A method, comprising:
placing a plurality of tray inserts into tray insert openings of a growing tray of a plant growing tray system, wherein tray locking points secure each of the plurality of tray inserts within the plurality of tray insert openings;
placing the plant growing tray system into a grow module, wherein the growing tray includes a pallet stop to secure the growing tray within the grow module; and
removing the plant growing tray system from the grow module.

13. The method of claim 12, wherein the growing tray includes a transfer catch designed for compatibility with end of arm tooling implemented on an automated tray transferring device and the plant growing tray system is placed into and removed from the grow module by the automated tray transferring device.

14. The method of claim 12, further comprising:
placing at least one plant vessel into at least one of the plurality of tray inserts.

15. The method of claim 14, wherein the at least one plant vessel is at least one of:
a sausage-type plant vessel; and
a pillow-shaped plant vessel.

16. The method of claim 14, wherein the at least one plant vessel is at least one of a round plant vessel and a rectangular plant vessel.

17. The method of claim 14, further comprising:
populating the at least one plant vessel containing at least one of a seed and a plant.

18. The method of claim 17, further comprising:
transporting the plant growing tray system from the grow module to a fertigation station;
fertigating the at least one plant vessel containing the at least one of the seed and the plant; and
returning the plant growing tray system to the grow module from the fertigation station.

19. The method of claim 18, further comprising:
configuring the fertigation station with a gripper to keep the at least one plant vessel seated in the at least one of the plurality of tray inserts during fertigation,
wherein the at least one of the plurality of tray inserts is configured with gripper hold-down slots configured to interface with the gripper.

20. The method of claim 17, further comprising:
removing the plant growing tray system from the grow module at the end of a growth cycle for a grown plant grown in the at least one plant vessel; and
removing the at least one plant vessel containing the grown plant from the plant growing tray system.
